(19) United States
(12) Patent Application Publication
(10) Pub. No.: US 2026/0260091 A1
(43) Pub. Date: Sep. 3, 2026

(54) METHODS, APPARATUS, AND ARTICLES OF MANUFACTURE TO GENERATE HARDWARE-AWARE MACHINE LEARNING MODEL ARCHITECTURES FOR MULTIPLE DOMAINS WITHOUT TRAINING

(71) Applicant: Intel Corporation, Santa Clara, CA (US)

(72) Inventors: Jian ZHANG, Shanghai (CN); Bin DING, Shanghai (CN); Tianyi LIU, Shanghai (CN)

(73) Assignee: Intel Corporation, Santa Clara, CA (US)

(21) Appl. No.: 18/995,737

(22) PCT Filed: Sep. 29, 2022
(86) PCT No.: PCT/CN2022/122927

§ 371 Date: Jan. 16, 2025

(51) Int. Cl. G06N 3/04; G06N 3/0985

(52) U.S. Cl. CPC G06N 3/04; G06N 3/0985

(57) ABSTRACT

Disclosed is a technical solution to generate hardware-aware machine learning (ML) model architectures for multiple domains without training. An example apparatus includes at least one memory, machine readable instructions, and processor circuitry to at least one of instantiate or execute the machine readable instructions. The example processor circuitry is to generate multiple candidate architectures for a ML model based on target hardware with which the ML model is to be executed and a search space corresponding to the multiple domains. Additionally, the example processor circuitry is to compute respective composite scores for the multiple candidate architectures, the respective composite scores based on respective latency scores for the multiple candidate architectures. The example processor circuitry is also to select an architecture for the ML model from the multiple candidate architectures for the ML model, the selected architecture corresponding to a composite score associated with the selected architecture that satisfies a criterion.

### FIELD OF THE DISCLOSURE

This disclosure relates generally to machine learning and, more particularly, to methods, apparatus, and articles of manufacture to generate hardware-aware machine learning model architectures for multiple domains without training.

### BACKGROUND

Machine learning models, such as neural networks, are useful tools that have demonstrated their value solving complex problems regarding pattern recognition, natural language processing, automatic speech recognition, etc. Neural networks operate, for example, using artificial neurons arranged into layers that process data from an input layer to an output layer, applying weighting values to the data during the processing of the data. Such weighting values are determined during a training process. The number of layers in a neural network corresponds to the network's depth with more layers corresponding to a deeper network.

### BRIEF DESCRIPTION OF THE DRAWINGS

FIG. 1 is a network diagram including an example model generation controller.

FIG. 2 is a block diagram of the model generation controller of FIG. 1 to generate and evaluate one or more candidate architectures for one or more machine learning models to determine one or more architectures for the one or more machine learning models that satisfy one or more criteria (e.g., a highest score, a best architecture, a most suitable architecture, etc.).

FIG. 3 is a table illustrating an example configuration file for the model generation controller of FIGS. 1 and/or 2.

FIG. 4 is a block diagram of an example transformer-based supernetwork framework of example supernetworks disclosed herein.

FIG. 5 is a visual representation of an example pipeline executed by the model generation controller of FIGS. 1 and/or 2 to generate a desired (e.g., optimal, best, etc.) architecture for a machine learning model.

FIG. 6 is a flowchart representative of example machine readable instructions and/or example operations that may be executed and/or instantiated by example processor circuitry to implement the model generation controller of FIGS. 1 and/or 2 to generate machine learning model architectures.

FIG. 7 is a flowchart representative of example machine readable instructions and/or example operations that may be executed and/or instantiated by example processor circuitry to implement the model generation controller of FIGS. 1 and/or 2 to compute a composite score a candidate machine learning model architecture.

FIG. 8 illustrates graphical illustrations comparing performance of the model generation controller of FIGS. 1 and/or 2 and other neural architecture search approaches.

FIG. 9 is a block diagram of an example processor platform including processor circuitry structured to execute the example machine readable instructions and/or the example operations of FIGS. 6 and/or 7 to implement the model generation controller of FIGS. 1 and/or 2.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 6 and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s). In some examples, ASICs are referred to as application specific integrated circuitry.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

As described above, neural networks operate, for example, using artificial neurons arranged into layers that process data from an input layer to an output layer, applying weighting values to the data during the processing of the data. Models may be developed and/or trained to operate in different domains. Example domains include computer vision (CV) domain, natural language processing (NLP domain), and recommendation system (RecSys) domain, among others. Typically, to develop a machine learning model, a human expert (e.g., an engineer) adjusts aspects of the model until the human expert achieves a desired (e.g., optimal) model. For example, the human expert may adjust the model architecture and/or hyperparameters of the model to give the best performance for that model on a given task.

Automated machine learning (ML) is a field of machine learning that seeks to automate the process of developing a desired (e.g., best, optimal, etc.) model. Neural architecture search (NAS) programs have become an increasingly popular automated ML approach due to the tendency of NAS-developed models to outperform human-developed models. Generally, NAS programs search through a space of available model architectures and a space including combinations of available hyperparameters to identify the best combination of model architecture and/or hyperparameters for a given task.

While NAS is a promising approach, such programs are generally limited to a single domain. That is, NAS programs can develop highly performant models for tasks of one domain, but not for tasks of other domains. For example, NAS programs for convolutional neural networks (CNNs) are well suited to CV tasks while NAS programs for recurrent neural networks (RNNs) are well suited for NLP tasks. Also, developing a NAS program for a particular domain requires specific domain knowledge to construct a unique search space for the target task(s). As such, it is difficult to adapt these domain-specific search spaces and model architectures to other domains.

Additionally, NAS programs typically require a large amount of computing resources. For example, the search spaces for NAS programs are typically large (e.g., encompassing ten billion possible architectures) and existing NAS programs generally require iterative training and evaluation of candidate architectures to determine whether a candidate architecture satisfies a threshold or other criterion. Such NAS programs are not suited for general purpose processor circuitry (such as CPUs and some edge devices) because the training-based performance predictors utilized to evaluate candidate architectures require intensive computation power for iterative evaluation. Furthermore, the performance predictors are training-based and therefore require data for performance evaluation. This requirement for data complicates the computational burden for tasks having large datasets (e.g., on the order of 10s of thousands of elements). As such, existing NAS programs are typically executed on accelerators (such as GPUs or special purpose circuitry), but even then, a NAS can require multiple accelerators executing for hundreds or even thousands of days depending on the complexity of the search space.

Furthermore, many NAS programs are hardware unaware. That is, many NAS programs do not consider the target hardware with which a model is to be executed when developing an architecture for the model. Such hardware-unawareness poses difficulties for deployment in different devices, especially for those devices that are resource constrained, such as edge devices and mobile devices, among others. While some NAS programs consider target hardware, doing so exacerbates the computing resource requirements of NAS programs. For example, determining a suitable model architecture for different target hardware requires a specific search space that can further complicate the search.

Some NAS programs have taken a one-shot approach to address the huge computational burden of NAS. Under such one-shot NAS approaches, a general model (e.g., a supernetwork) is selected by the NAS program and sub-models are selected from the general model for a particular target hardware. In such approaches, a supernetwork is implemented as a directed acyclic graph (DAG) where sub-graphs of the DAG represent candidate models and a candidate model is selected using a lightweight performance predictor instead of iterative training and evaluation. As used herein, supernetwork and supernet are used interchangeably. Additionally, some NAS programs have implemented a proxy for performance estimation instead of a performance predictor to further reduce the computational burden of evaluating a candidate model. A proxy may be implemented by a measure of some inherent characteristic of a model that does not require the execution of the model to train and evaluate. As such, proxies are sometimes referred to as zero-cost proxies.

However, zero-cost proxies are limited in that they only consider one or two characteristics of a model, but not a comprehensive list of characteristics of the model. For example, some proxy-based approaches utilize the expressivity of a model as the proxy while others utilize a combination of the diversity and the saliency of a model as the proxy. Expressivity, diversity, and saliency will be discussed further below. This limited zero-cost evaluation of models causes zero-cost proxy NAS approaches to perform well for one task or domain but perform poorly for other tasks or domains.

To overcome the limitations of NAS, one-shot NAS, and zero-cost proxy NAS approaches, examples disclosed herein include a multi-model, hardware aware, training-free NAS approach to construct compact (e.g., low computation complexity) model architectures for target hardware. For example, disclosed examples construct compact neural network architectures directly from a human-designed search space that is applicable to multiple domains and multiple model types. Examples disclosed herein utilize a hardware-aware search strategy based on one or more thresholds (e.g., model parameter size budgets) to determine a desired (e.g., optimal, best, etc.) model architecture and utilize a wholistic hardware-aware train-free score to evaluate the performance of candidate architectures rather than training each candidate architecture and acquiring the associated accuracy. For example, the wholistic train-free score considers the expressivity, complexity, saliency, diversity, and latency of candidate architectures.

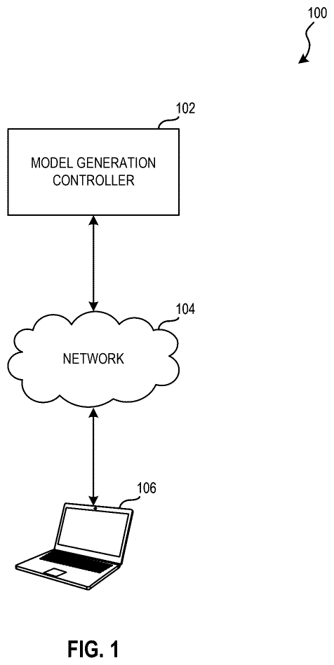

FIG. 1 is a network diagram 100 including an example model generation controller 102. The example network diagram 100 includes the example model generation controller 102, an example network 104, and an example target hardware platform 106. In the example of FIG. 1, the example model generation controller 102, the example target hardware platform 106, and/or one or more additional devices are communicatively coupled via the example network 104.

In the illustrated example of FIG. 1, the model generation controller 102 is implemented by processor circuitry. In the example of FIG. 1, the model generation controller 102 is a server that implements a machine learning model (e.g., a parent model) to generate architectures for one or more child models based on information specific to a target hardware platform. Additionally, in the example of FIG. 1, the model generation controller 102 trains the one or more child models.

In the illustrated example of FIG. 1, the model generation controller 102 implements a multi-model, hardware aware, training-free NAS to construct compact, lightweight model architectures for a target hardware such as the target hardware platform 106. In the example of FIG. 1, the model generation controller 102 constructs compact neural architectures directly from manually designed search space that supports multiple domains. The example model generation controller 102 leverages a hardware-aware search strategy to determine a desired (e.g., optimal, best, etc.) network. Additionally, the example model generation controller 102 employs a zero-cost, train-free scoring technique to evaluate the performance of a candidate network architecture rather than training each candidate architecture and acquiring a corresponding accuracy and/or another model specific target metric.

In the illustrated example of FIG. 1, the model generation controller 102 builds child models (e.g., child networks) based on human-designed search space that is unified across multiple domains, multiple model types, and a shared model framework. In examples disclosed herein, the model generation controller 102 builds candidate child model architectures using a transformer-based model framework that is adjusted according to one or more supernets corresponding to the one or more domains supported by the model generation controller 102. Additionally, the example model generation controller 102 develops candidate architectures for child models based on target hardware with which the child models are to be executed and one or more domains in which the child models are to operate. In the example of FIG. 1, the model generation controller 102 implements a zero-cost, train-free NAS approach to evaluate candidate architectures for child models.

Many different types of machine learning techniques and/or machine learning architectures may be used to implement the model generation controller 102. In examples disclosed herein, one or more components (e.g., search engine circuitry) of the model generation controller 102 is implemented by a hardware-aware evolution algorithm executed and/or instantiated on processor circuitry. Using a hardware-aware evolution algorithm enables the model generation controller 102 to focus the search for candidate architectures on relevant portions of the search space while enforcing an upper bound on the latency and parameters of sampled architectures and rejecting candidate architectures that exceed this upper bound to accommodate target hardware requirements. Other types of machine learning techniques could additionally or alternatively be used as a hardware-aware search algorithm such as reinforcement learning, random search, Bayesian optimization, gradient optimization, etc.

In examples disclosed herein, one or more components (e.g., training circuitry) of the model generation controller 102 utilizes stochastic gradient descent to train child models. However, any other training algorithm may additionally or alternatively be used. In examples disclosed herein, training is performed until one or more thresholds are met. For example, the model generation controller 102 is trained to satisfy a threshold corresponding to requirements of the hardware that is to implement the model generation controller 102 during inference. Additionally or alternatively, the model generation controller 102 is trained to satisfy a threshold corresponding to requirements (e.g., accuracy) on target hardware for candidate architectures for child models. In examples disclosed herein, training is performed at a central server of the developer of the model generation controller 102. Training is performed using hyperparameters that control how the learning is performed (e.g., a learning rate, a number of layers to be used in the machine learning model, etc.). In examples disclosed herein, hyperparameters that control the weight to be attributed to characteristics of a candidate architecture when computing the zero-cost, train-free score for a candidate architecture. Such hyperparameters are selected by, for example, a developer of the model generation controller 102.

Training is performed using training data. In examples disclosed herein, the training data originates from publicly available datasets. Because supervised training is used, the training data is labeled. Labeling is applied to the training data by a human. In some examples, the training data is pre-processed to, for example, identify labels, reformat the training data into a format supported by the model generation controller 102, normalize the training data, etc. In some examples, the training data is sub-divided into a training dataset and a validation dataset.

Once training is complete, the model is deployed for use as an executable construct that processes an input and provides an output based on the network of nodes and connections defined in the model. The model may be stored at a central server and offered as a service or for download. For example, the model generation controller 102 can offer one or more services and/or products to end-users. In a service-based implementation, the model generation controller 102 can provide one or more trained models (e.g., candidate models) for download, host a web-interface to access the model generation controller 102, among others. In a product-based implementation, the model generation controller 102 can offer a software package that implements the functionality of the model generation controller 102. In this manner, the end-user can implement the model generation controller 102 locally (e.g., at the target hardware platform 106). In some examples, the model generation controller 102 can provide end-users with a plugin that is compatible with a ML development program such as TensorFlow, Keras, etc. In such examples, the plugin implements the functionality of the model generation controller 102.

In the illustrated example of FIG. 1, the network 104 is the Internet. However, the example network 104 may be implemented using any suitable wired and/or wireless network(s) including, for example, one or more data buses, one or more Local Area Networks (LANs), one or more wireless LANs, one or more cellular networks, one or more private networks, one or more public networks, etc. In additional or alternative examples, the network 104 is an enterprise network (e.g., within businesses, corporations, etc.), a home network, among others. The example network 104 enables the model generation controller 102 and the target hardware platform 106 to communicate.

In the illustrated example of FIG. 1, the target hardware platform 106 is implemented by a laptop computer. In additional or alternative examples, the target hardware platform 106 can be implemented by a mobile phone, a tablet computer, a desktop computer, a server, among others. In some examples, the target hardware platform 106 can be implemented by processor circuitry, analog circuit(s), digital circuit(s), logic circuit(s), programmable processor(s), programmable microcontroller(s), GPU(s), DSP(s), ASIC(s), programmable logic device(s) (PLD(s)), and/or field programmable logic device(s) (FPLD(s)) such as FPGAs.

In the illustrated example of FIG. 1, the target hardware platform 106 can subscribe to and/or otherwise purchase product(s) from the model generation controller 102 to access a trained ML model that is optimized for the target hardware platform 106. For example, the target hardware platform 106 can access the trained ML model by downloading the model from the model generation controller 102, accessing a web-interface hosted by the model generation controller 102 and/or another device, among other techniques. In some examples, the target hardware platform 106 can install a plugin to a ML training application. In such an example, the plugin implements the model generation controller 102. In additional or alternative examples, the target hardware platform 106 can download a software application to implement the model generation controller 102.

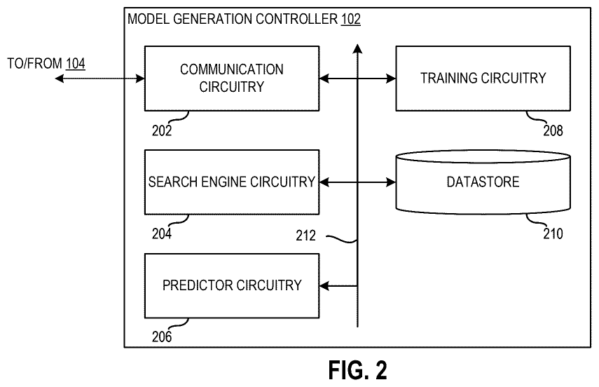

FIG. 2 is a block diagram of the model generation controller 102 of FIG. 1 to generate one or more candidate architectures for one or more ML models and to train the one or more ML models. The model generation controller 102 of FIG. 2 may be instantiated (e.g., creating an instance of, bring into being for any length of time, materialize, implement, etc.) by processor circuitry such as a central processing unit executing instructions. Additionally or alternatively, the model generation controller 102 of FIG. 2 may be instantiated (e.g., creating an instance of, bring into being for any length of time, materialize, implement, etc.) by an ASIC or an FPGA structured to perform operations corresponding to the instructions (e.g., operations corresponding to instructions). It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

In the illustrated example of FIG. 2, the model generation controller 102 includes example communication circuitry 202, example search engine circuitry 204, example predictor circuitry 206, example training circuitry 208 and an example datastore 210. In the example of FIG. 2, any of the communication circuitry 202, the search engine circuitry 204, the predictor circuitry 206, the training circuitry 208, and/or the datastore 210 can communicate via an example communication bus 212. In examples disclosed herein, the communication bus 212 may be implemented using any suitable wired and/or wireless communication. In additional or alternative examples, the communication bus 212 includes software, machine readable instructions, and/or communication protocols by which information is communicated among the communication circuitry 202, the search engine circuitry 204, the predictor circuitry 206, the training circuitry 208, and/or the datastore 210.

In the illustrated example of FIG. 2, the communication circuitry 202 interfaces with the network 104. For example, the communication circuitry 202 receive one or more inputs indicative (e.g., at least one input indicative) of a domain in which a ML model is to operate and/or target hardware with which to execute the ML model. After the model generation controller 102 generates an architecture for the ML model and trains the ML model, the communication circuitry 202 communicates the trained ML model to a client device (e.g., the target hardware platform 106).

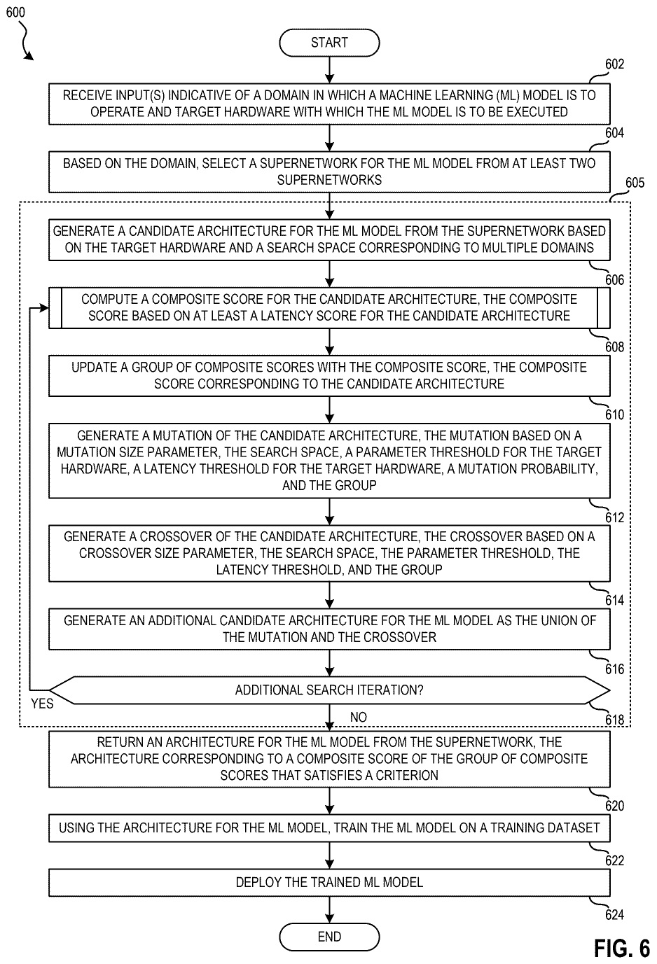

In some examples, the communication circuitry 202 receives one or more configuration files indicative of a search space for the ML model that is applicable to one or more domains and/or one or more supernets for the ML model. For example, a first supernet for the ML model corresponds to a first domain and a second supernet for the ML model corresponds to a second domain. In such examples, the communication circuitry 202 forwards the configuration file(s) to the search engine circuitry 204. In some examples, the configuration file(s) are stored in the datastore 210 after receipt. In additional or alternative examples, configuration file(s) are preloaded into the datastore 210. In some examples, the communication circuitry 202 is instantiated by processor circuitry executing communication instructions and/or configured to perform operations such as those represented by the flowchart of FIG. 6.

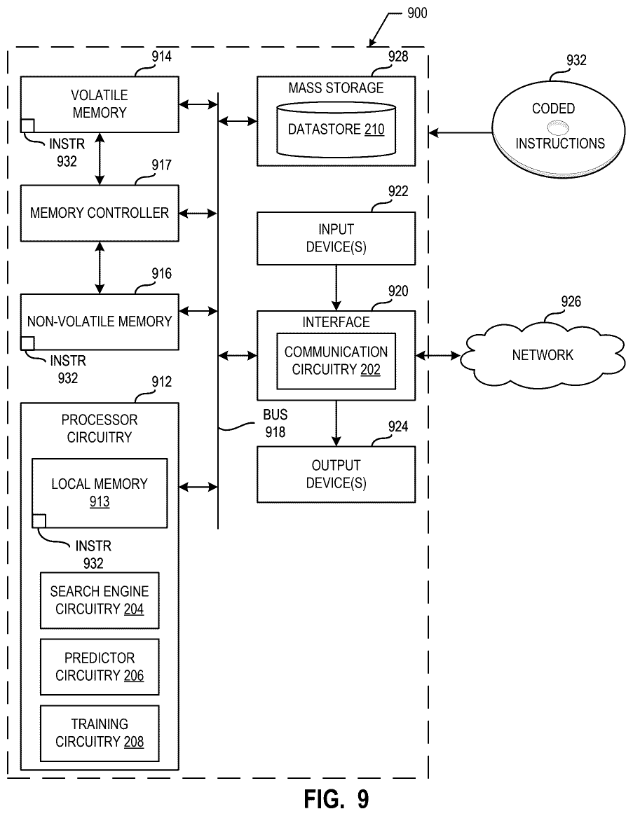

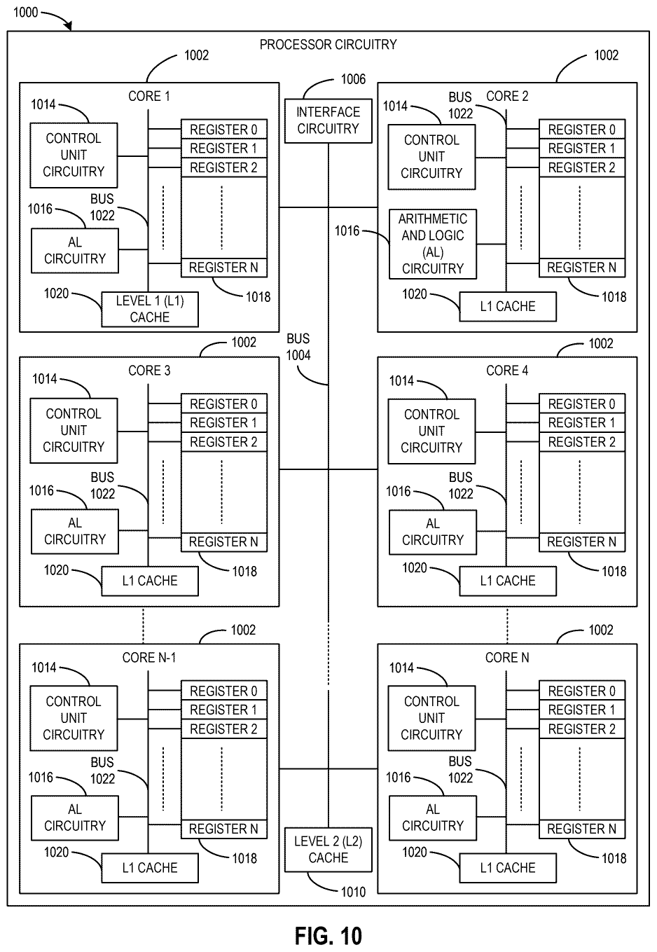

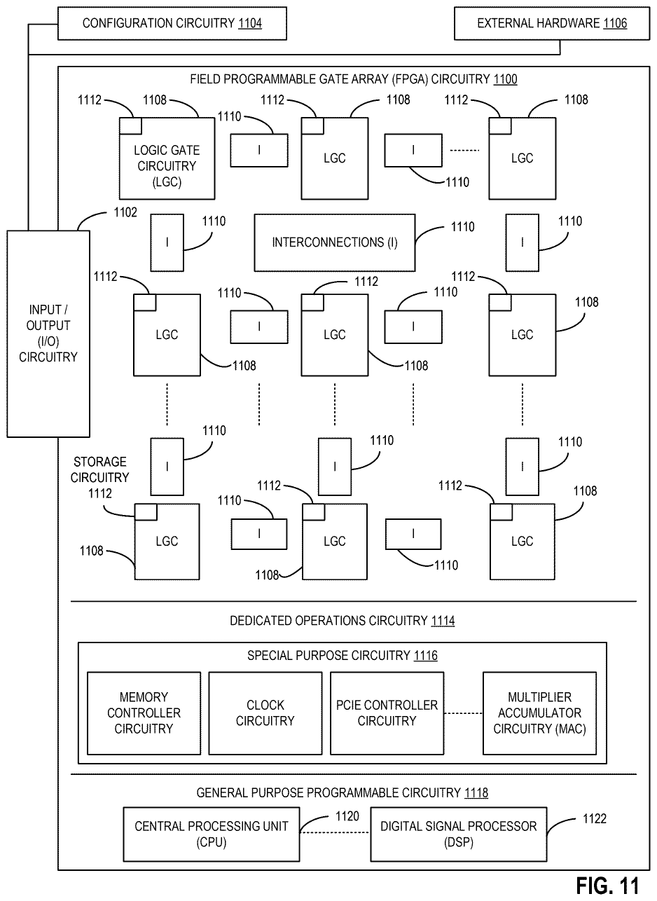

In some examples, the model generation controller 102 includes means for communicating. For example, the means for communicating may be implemented by the communication circuitry 202. In some examples, the communication circuitry 202 may be instantiated by processor circuitry such as the example processor circuitry 912 of FIG. 9. For instance, the communication circuitry 202 may be instantiated by the example microprocessor 1000 of FIG. 10 executing machine executable instructions such as those implemented by at least block 602 of FIG. 6. In some examples, the communication circuitry 202 may be instantiated by hardware logic circuitry, which may be implemented by an ASIC, XPU, or the FPGA circuitry 1100 of FIG. 11 structured to perform operations corresponding to the machine readable instructions. Additionally or alternatively, the communication circuitry 202 may be instantiated by any other combination of hardware, software, and/or firmware. For example, the communication circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

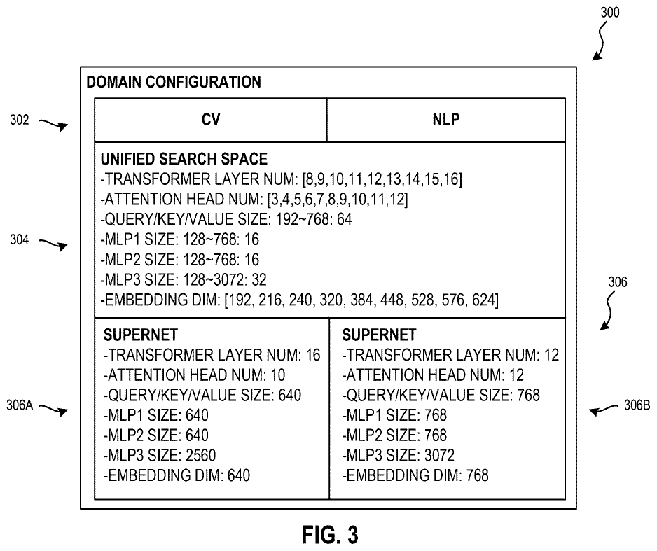

FIG. 3 is a table illustrating an example configuration file 300 for the model generation controller 102 of FIGS. 1 and/or 2. In some examples, the configuration file 300 can be formatted as a Yet Another Markup Language (YAML) file. In additional or alternative examples, the configuration file 300 may be formatted in any manner. In the example of FIG. 3, the configuration file 300 includes an example domain section 302, an example search space section 304, and an example supernet section 306. In examples disclosed herein, search spaces for ML models are unified search spaces that are applicable to multiple domains and/or multiple model types. For example, a search space can be applicable to the computer vision domain, the natural language processing domain, and the recommender system domain. In this manner, search spaces may be unified across multiple domains. In the example of FIG. 3, the domain section 302 indicates that the configuration set forth in the configuration file 300 supports the CV domain and the NLP domain and is therefore unified across the CV and NLP domains.

Additionally, example unified search spaces disclosed herein are applicable to multiple model types. For example, search spaces include building blocks for CNNs, transformer models, multilayer perceptron (MLP) models, among others. In this manner, in addition to being unified across multiple domains, disclosed search spaces are unified across multiple model types. Providing a unified search space that supports multiple model types allows the model generation controller 102 to support different domains. In the example of FIG. 3, the search space section 304 indicates that the search space for the configuration file 300 supports supernets utilizing transformer models and/or MLP models. The example transformer layers in supported supernets can range from 8 to 16 with each transformer layer having between 3 and 12 multi-head self-attention (MSA) sub-layers; query, key, and value matrices ranging from 192 to 768 elements in size with 64-element step sizes; embedding dimensions of 192 elements, 216 elements, 240 elements, 320 elements, 384 elements, 448 elements, 528 elements, 576 elements, and 624 elements; and three MLP layers. The three MLP layers include a first MLP layer ranging from 128 to 768 elements in size with a 16-element step size, a second MLP layer ranging from 128 to 768 elements with a 16-element step size, and a third MLP layer ranging from 128 to 3,072 elements with a 32-element step size. In other examples, parameters of the supernet layers may be different. For example, a developer can change parameters included in a configuration file based on his or her application.

In examples disclosed herein, unified search spaces are developed to include optimized building blocks (e.g., ML operations) that have been incorporated into the search space based on a priori knowledge such as the typical properties of architectures that are well-suited for a task. By including the optimized building blocks and utilizing the a priori knowledge, examples disclosed herein reduce the search space size. In the example of FIG. 3, the supernet section 306 indicates the supernets supported by the configuration of FIG. 3. For example, the supernet section 306 includes an example first supernet 306A corresponding to the CV domain and an example second supernet 306B corresponding to the NLP domain.

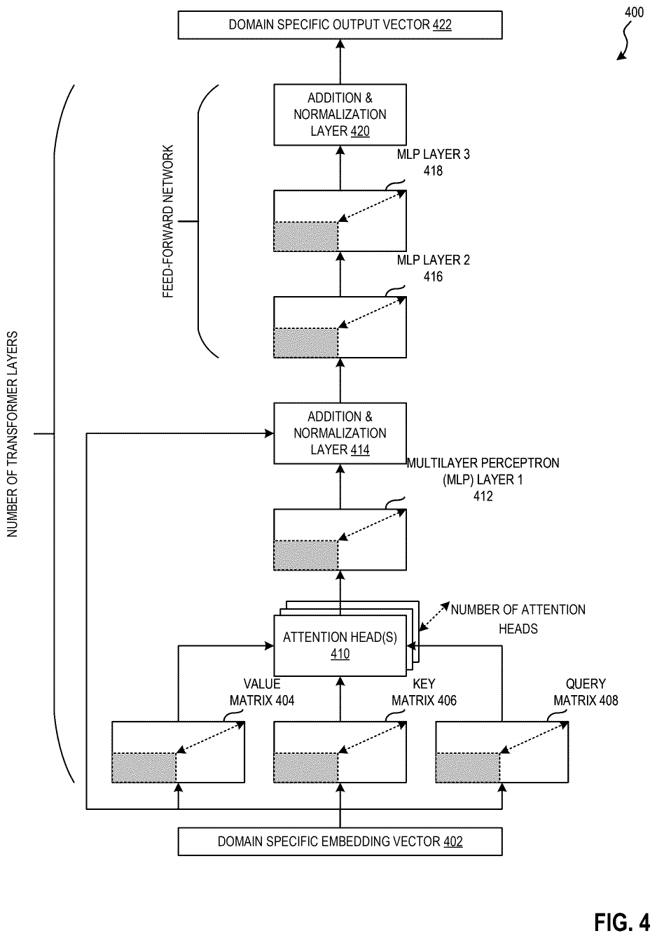

FIG. 4 is a block diagram of an example supernet framework 400 of example supernets disclosed herein. In the example of FIG. 4, the supernet framework 400 represents each layer of a supernet and is applicable to both the first supernet 306A (which is applicable to the CV domain) and the second supernet 306B (which is applicable to the NLP domain). As such, in addition to being unified across multiple domains and multiple model types, disclosed search spaces are unified across a single supernet framework. In the example of FIG. 4, the supernet framework 400 is a unified transformer. As such, the search space of FIGS. 3 and 4 is a unified transformer-based search space.

In the illustrated example of FIG. 4, each transformer layer of the example supernet framework 400 receives an example domain specific embedding vector 402. The domain specific embedding vector 402 is fed to an example value matrix 404, an example key matrix 406, and an example query matrix 408. The value matrix 404, the key matrix 406, and the query matrix 408 are fed into one or more example attention heads 410. For example, the number of attention heads included in a transformer layer may be specified in the configuration file 300. The one or more outputs of the one or more attention heads 410 are fed into an example first MLP layer 412. The output of the first MLP layer 412 and the domain specific embedding vector 402 are fed into an example first addition and normalization layer 414.

In the illustrated example of FIG. 4, the output of the first addition and normalization layer 414 is fed into an example second MLP layer 416. The output of the second MLP layer 416 is fed into an example third MLP layer 418 and the output of the third MLP layer 418 is fed into an example second addition and normalization layer 420. The output of the second addition and normalization layer 420 is an example domain specific output vector 422. The domain specific output vector 422 may be fed into any subsequent transformer layers. Additionally, in the example of FIG. 4, the second MLP layer 416, the third MLP layer 418, and the second addition and normalization layer 420 form an internal feed-forward network of each transformer layer. In example disclosed herein, the number of MLP layers, the number of transformer layers, the number of attention heads, and the size of the query, key, and values included in a supernet may vary. For example, the number of MLP layers, the number of transformer layers, the number of attention heads, and the size of the query, key, and values may be specified in the configuration file 300.

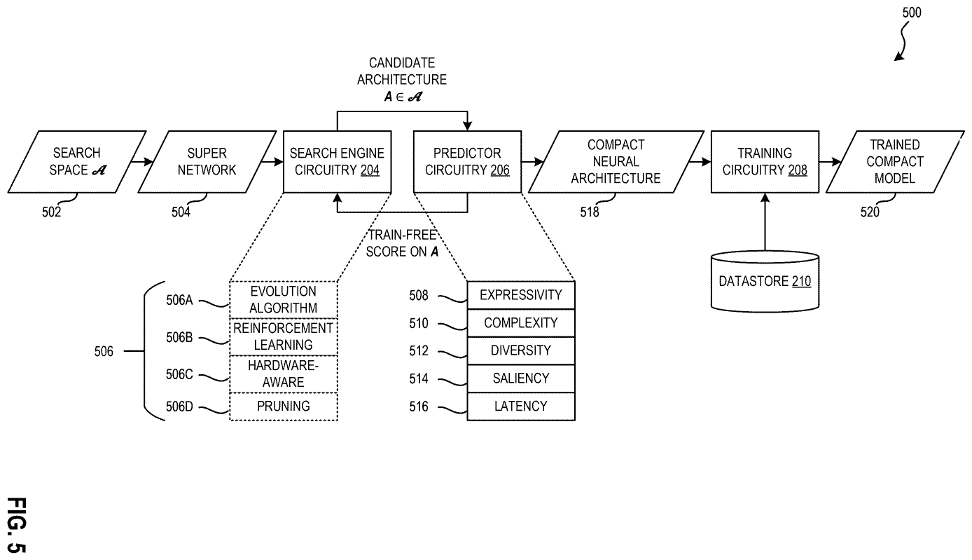

Returning to FIG. 2, in response to a request to generate a ML model, the search engine circuitry 204 selects a supernet for the ML model based on the domain in which the ML model is to operate. The search engine circuitry 204 selects the supernet from at least two supernets corresponding to respective domains of the multiple domains supported by the search space. From the selected supernet, the search engine circuitry 204 generates candidate architectures for the ML model by searching through the unified search space according to a search algorithm. In examples disclosed herein, the search engine circuitry 204 supports multiple search algorithms, some of which will be discussed in connection with FIG. 5.

In this manner, the search engine circuitry 204 supports pluggable search algorithms (e.g., one or more search strategies that can be “plugged” into and “unplugged” from the search engine circuitry 204). In the example of FIG. 2, the search engine circuitry 204 generates candidate architectures for the ML model by searching through the unified search space based on target hardware with which the ML model is to be executed (e.g., a hardware-aware search algorithm). For example, Pseudocode 1 illustrates this hardware-aware search algorithm with evolution (e.g., an evolution algorithm (EA)) that may be implemented by the model generation controller 102.

Pseudocode 1

| | |
|---|---|
| 1. | F₀ = Initial_Architecture(K, S, Tₛ, Tₗ) |
| 2. | Topk = Φ |
| 3. | for i = 1:N do |
| 4. | DE_{SCORE} = DE_{SCORE}(Fᵢ₋₁) |
| 5. | Topk = update_topk(Fᵢ₋₁, DE_{SCORE}, Topk) |
| 6. | Fₘᵤₜₐₜᵢₒₙ = Mutation(Nₘ, S, Tₛ, Tₗ, p, Topk) |
| 7. | F_{crossover} = Crossover(N_{c}, S, Tₛ, Tₗ, Topk) |
| 8. | Fᵢ = Fₘᵤₜₐₜᵢₒₙ ∪ F_{crossover} |
| 9. | end |
| 10. | Return the network architecture with the best DE_{SCORE} in Topk |

In the illustrated example of FIG. 2, the search engine circuitry 204 generates an initial candidate architecture (F₀) for the ML model from the supernet based on a number (K) of candidate architectures to sample from the supernet, the search space (S), a parameter threshold (Tₛ) for the target hardware, and a latency threshold (Tₗ) for the target hardware (e.g., line 1 of Pseudocode 1). In the example of FIG. 2, the search engine circuitry 204 initializes a variable (Topk) in the datastore 210 to store composite scores and corresponding candidate architectures (e.g., line 2 of Pseudocode 2). For example, the variable may be a multi-dimensional matrix or tensor (Φ) formatted to store a composite score and a corresponding candidate architecture. In examples disclosed herein, the variable may be referred to as a candidate architecture tracking variable or a group of composite scores. After a score is generated for the initial candidate architecture, the search engine circuitry 204 updates the candidate architecture tracking variable (e.g., the group of composite scores) with the composite score (DE_{SCORE}) and corresponding candidate architecture (Fᵢ₋₁) (e.g., line 5 of Pseudocode 1).

In the illustrated example of FIG. 2, the search engine circuitry 204 generates a mutation (Fₘᵤₜₐₜᵢₒₙ) of the candidate architecture (e.g., line 6 of Pseudocode 1). For example, the mutation corresponds to the search engine circuitry 204 randomly (e.g., pseudo-randomly) changing one or more building blocks (e.g., ML operations) of the previous candidate architecture. Generating a mutation increases the diversity of the candidate architecture and allows the search engine circuitry 204 to avoid reaching a local optimal architecture but not a global optimal architecture. In the example of FIG. 2, the search engine circuitry 204 generates mutations based a mutation size parameter (Nₘ), the search space (S) for the ML model, the parameter threshold (Tₛ) of the target hardware, the latency threshold (Tₗ) for the target hardware, a mutation probability (p), and the candidate architecture tracking variable (Topk) (e.g., the group of composite scores).

In the illustrated example of FIG. 2, the search engine circuitry 204 generates a crossover (F_{crossover}) of the candidate architecture (e.g., line 7 of Pseudocode 1). For example, the crossover corresponds to the search engine circuitry 204 swapping one or more building blocks of the previous candidate architecture with other building blocks in a relevant subspace of the search space. Generating a crossover mixes candidate architectures in the relevant subspace and allows for the search engine circuitry 204 to converge on a desired (e.g., optimal) architecture in the relevant subspace. In the example of FIG. 2, the search engine circuitry 204 generates crossovers based a crossover size parameter (N_{c}), the search space (S) for the ML model, the parameter threshold (Tₛ) of the target hardware, the latency threshold (Tₗ) for the target hardware, and the candidate architecture tracking variable (Topk) (e.g., the group of composite scores).

In the illustrated example of FIG. 2, the parameter threshold utilized by the search engine circuitry 204 corresponds to a number of parameters (e.g., weights) that the ML model is permitted to have when deployed to the target hardware. The example latency threshold utilized by the search engine circuitry 204 corresponds to a duration that is permitted for the ML model to complete an inference on the target hardware. By implementing the parameter threshold and the latency threshold, the search engine circuitry 204 filters out (e.g., focuses the search on) candidate architectures that are suitable for the target hardware (e.g., the target hardware platform 106) in a coarse-grained manner.

In the illustrated example of FIG. 2, the search engine circuitry 204 generates an additional candidate architecture (Fᵢ) based on a combination of the mutation of the previous candidate architecture and the crossover of the previous candidate architecture (e.g., line 8 of Pseudocode 1). In the example of FIG. 2, the search engine circuitry 204 generates additional candidate architectures as the union of the mutation and the crossover. In additional or alternative examples, the search engine circuitry 204 generates additional candidate architectures as any other combination of the mutation and the crossover.

Subsequently, the search engine circuitry 204 updates the candidate architecture tracking variable (e.g., the group of composite scores) with composite scores for candidate architectures and generates additional candidate architectures for the ML model from the supernet for a predefined number (N) of iterations. In response to completing the predefined number of iterations, the search engine circuitry 204 returns an architecture for the ML model from the supernet (e.g., line 10 of Pseudocode 1). The returned architecture corresponds to a candidate score of the candidate architecture tracking variable (e.g., the group of composite scores) that satisfies a criterion. In the example of FIG. 2, the criterion corresponds to a largest one of the composite scores. In additional or alternative examples, other criteria may be used, such as returning a score that satisfies (e.g., is equal to or greater than) a threshold. In some examples, the search engine circuitry 204 is instantiated by processor circuitry executing search engine instructions and/or configured to perform operations such as those represented by the flowchart of FIG. 6.

In some examples, the model generation controller 102 includes means for searching. For example, the means for searching may be implemented by the search engine circuitry 204. In some examples, the search engine circuitry 204 may be instantiated by processor circuitry such as the example processor circuitry 912 of FIG. 9. For instance, the search engine circuitry 204 may be instantiated by the example microprocessor 1000 of FIG. 10 executing machine executable instructions such as those implemented by at least blocks 604, 606, 610, 612, 614, 616, 618, and 620 of FIG. 6. In some examples, the search engine circuitry 204 may be instantiated by hardware logic circuitry, which may be implemented by an ASIC, XPU, or the FPGA circuitry 1100 of FIG. 11 structured to perform operations corresponding to the machine readable instructions. Additionally or alternatively, the search engine circuitry 204 may be instantiated by any other combination of hardware, software, and/or firmware. For example, the search engine circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the predictor circuitry 206 computes composite scores for candidate architectures generated during execution of the search algorithm by the search engine circuitry 204 (e.g., line 4 of Pseudocode 1). For example, the predictor circuitry 206 utilizes a comprehensive zero-cost proxy to predict the accuracy of a candidate architecture instead of fully training and validating a ML model having the candidate architecture. In this manner, the comprehensive zero-cost proxy is a train-free score. In the example of FIG. 2, the predictor circuitry 206 computes a composite score for a candidate architecture as a combination of an expressivity of the candidate architecture, a complexity of the candidate architecture, a diversity of the candidate architecture, a saliency of the candidate architecture, and a latency of the candidate architecture. In the example of FIG. 2, the predictor circuitry 206 computes a composite score for a candidate architecture according to Equation 1 below:

$${DE}_{SCORE} = ( {α}_{1} {D}_{EXP} + {α}_{2} {D}_{COM} + {α}_{3} {D}_{DIV} + {α}_{4} {D}_{SAL} ) \cdot {D}_{LAT} \qquad Equation l$$

In Equation 1, DE_{SCORE} represents the composite score for a candidate architecture, D_{EXP} represents the expressivity score for the candidate architecture, D_{COM} represents the complexity score for the candidate architecture, D_{DIV} represents the diversity score for the candidate architecture, D_{SAL} represents the saliency score for the candidate architecture, and D_{LAT} represents the latency score for the candidate architecture. Additionally, α₁, α₂, α₃, and α₄ represent hyperparameters for the expressivity score, the complexity score, the diversity score, and the saliency score, respectively. To compute a composite score (DE_{SCORE}) for a candidate architecture, the predictor circuitry 206 computes respective products of respective hyperparameters and the expressivity score, the complexity score, the diversity score, and the saliency score for a candidate architecture. Additionally, the predictor circuitry 206 computes the composite score (DE_{SCORE}) for the candidate architecture as the product of the latency score and the sum of the respective products. The search engine circuitry 204 then updates the search algorithm (e.g., lines 4-8 of Pseudocode 1) based on the composite score.

In the example of Equation 1, the hyperparameters α₁, α₂, α₃, and α₄ control whether a corresponding score is to be utilized for different model types that can be developed by the model generation controller 102. For example, the complexity score may be more relevant to evaluating MLP layers while the saliency score and diversity score may be more relevant to evaluating transformer layers. As such, in the example of FIG. 2, the predictor circuitry 206 utilizes binary values for the hyperparameters α₁, α₂, α₃, and α₄. In examples disclosed herein, the binary values are tuned by a developer of the model generation controller 102. In additional or alternative examples, the hyperparameters α₁, α₂, α₃, and α₄ may be implemented as continuous values ranging from, for example, zero to one.

In the illustrated example of FIG. 2, the predictor circuitry 206 utilizes expressivity as a measure of the ability of a candidate architecture to approximate complex functions. For example, the more expressible the architecture is (e.g., the larger the expressivity score), the more efficient the architecture can fit training data. For example, for a CNN including multiple layers, each layer having a convolutional operation followed by a rectified linear unit (ReLU) activation, expressivity can be measured by the Gaussian complexity of a candidate architecture. The predictor circuitry 206 computes Gaussian complexity according to Equation 2 below.

$${D}_{EXP} = log ( {E}_{x , δ} ‖ f ( x ) - f ( x + γδ ) ‖ ) \qquad Equation 2$$

In Equation 2, D_{EXP} represents the expressivity score of a candidate architecture, E_{x,δ} represents the expected value of some function having independent variables of an input (x) to the ML model and parameters (δ) of the ML model, ∥*∥ represents the Euclidean norm, f(*) represents a pre-global average pool feature map for the candidate architecture (F(*)), and γ represents a coefficient for the parameters (δ) of the ML model. When implementing Equation 2, the predictor circuitry 206 samples input (x) and parameters (δ) of the ML model with random (e.g., pseudo-random) numbers from a standard normal distribution (e.g., with a mean of zero and variance of one). In the example of FIG. 2, the predictor circuitry 206 evaluates Equation 2 with the coefficient (γ) for the parameters (δ) set to 0.01.

In the illustrated example of FIG. 2, the predictor circuitry 206 utilizes complexity as a measure of the ability of a candidate architecture to be optimized by gradient descent. For example, the architecture of a ML model can control how effectively gradient information can flow through the ML model. The complexity of a candidate architecture can be measured by a neural tangent kernel (NTK) score. The predictor circuitry 206 computes an NTK score according to Equation 3 below.

$${D}_{COM} = {E}_{x} \frac{{λ}_{max} ( \hat{Θ} ( x , x ) )}{{λ}_{min} ( \hat{Θ} ( x , x ) )} \qquad Equation 3$$

In Equation 3, D_{COM} represents the complexity score (e.g., the NTK score) of a candidate architecture, Eₓ represents the mean of some function having an independent variable of an input (x) to the ML model, \hat{Θ}(*) represents the NTK, λₘₐₓ represents a maximum eigen value of the NTK, and/min λₘᵢₙ represents a minimum eigen value of the NTK. In the example of FIG. 2, the predictor circuitry 206 computes an NTK (\hat{Θ}(*)) according to Equation 4 below.

$$\hat{Θ} ( x , {x}^{′} ) = J ( x ) {J ( {x}^{′} )}^{T} \qquad Equation 4$$

In Equation 4, J(x) represents the Jacobian evaluated at point x. When implementing Equations 3 and 4, the predictor circuitry 206 samples the input (x) with random (e.g., pseudo-random) numbers from a standard normal distribution. In the example of FIG. 2, the predictor circuitry 206 utilizes diversity as a measure of the ability of an MSA layer of a candidate architecture to capture distinct properties of an input that are embedded in different subspaces. For example, the higher the rank of a parameter (e.g., weight) matrix of an MSA layer, the higher the diversity score (e.g., the more diverse information the MSA layer can capture). In the example of FIG. 2, the predictor circuitry 206 computes diversity according to Equation 5 below.

$${D}_{DIV} = {\sum }_{m} {‖ \frac{\partial L}{\partial {W}_{m}} ‖}_{n u c} ⊙ {‖ {W}_{m} ‖}_{n u c} \qquad Equation 5$$

In Equation 5, D_{DIV} represents the diversity score of a candidate architecture, L represents the loss function of the ML model having parameters W for an MSA layer, ∥*∥_{nuc} represents the nuclear norm of the parameter (e.g., weight) matrix (W), and ⊙ represents the Hadamard product. When implementing Equation 5, the predictor circuitry 206 computes the sum of the Hadamard product of the nuclear norm of a weight and the nuclear norm of the corresponding gradient of the loss function for all weights of an MSA layer of a candidate architecture. In the example of FIG. 2, the predictor circuitry 206 utilizes saliency as a measure of the number of important parameters (e.g., weights) in a MLP layer of a candidate architecture. For example, saliency is a general metric of gradient-based scores for pruning parameters (e.g., to meet a parameter threshold) and is conserved in hidden units and layers of a candidate architecture. In the example of FIG. 2, the predictor circuitry 206 computes saliency according to Equation 6 below.

$${D}_{S A L} = {\sum }_{n} \frac{\partial L}{\partial {W}_{n}} ⊙ {W}_{n} \qquad Equation 6$$

In Equation 6, D_{SAL} represents the saliency score of a MLP layer of a candidate architecture, L represents the loss function of the ML model having parameters W for the MLP layer, and ⊙ represents the Hadamard product. When implementing Equation 6, the predictor circuitry 206 sums the Hadamard products of a weight and the corresponding gradient of the loss function for all weights of all MLP layers of a candidate architecture. In the example of FIG. 2, the predictor circuitry 206 utilizes latency as a measure of whether a candidate architecture can satisfy a latency requirement of target hardware. In this manner, latency can be used to limit a NAS to candidate architecture that will operate satisfactorily on target hardware. In the example of FIG. 2, the predictor circuitry 206 computes latency according to Equation 7 below.

$${D}_{L A T} = \frac{1}{1 + β \cdot {T}_{batch}} \qquad Equation 7$$

In Equation 7, D_{LAT} represents the latency score of a candidate architecture, T_{BATCH} represents an expected duration of an inference of the ML model when executed on target hardware for one batch of input data, and β represents a hyperparameter that controls the weight attributed to the latency score in the composite score (e.g., the ratio of the latency score to the other scores). In examples disclosed herein, β is a continuous variable that ranges between zero and one. As a default, in the example of FIG. 2, the predictor circuitry 206 evaluates Equation 7 with β set to one. In Equation 7, one is added to the denominator to avoid inaccurate latency scores when the expected duration of an inference (T_{BATCH}) is very small.

In examples disclosed herein, Equations 2, 3, 5, 6, and 7 are example equations utilized by the predictor circuitry 206 to calculate expressivity, complexity, diversity, saliency, and latency, respectively. In additional or alternative examples, the predictor circuitry 206 calculates expressivity, complexity, diversity, saliency, and latency in other manners. If the predictor circuitry 206 utilizes alternative equations to calculate expressivity, complexity, diversity, saliency, and latency, a developer of the predictor circuitry 206 should tune the equations to his or her application. For example, a developer of the predictor circuitry 206 may tune alternate equations based on the domains (e.g., CV domain, NLP domain, RecSys domain, etc.) supported by the model generation controller 102.

Pseudocode 2 illustrates an example composite score algorithm that may be implemented by the predictor circuitry 206.

Pseudocode 2

| | |
|---|---|
| 1. | Initialize all neurons in F(*) by [symbol] (0,1) |
| 2. | Sample x, δ ~ [symbol] (0,1). |
| 3. | Compute network expressivity score D_{EXP}, saliency score D_{SAL}, network |
| | complexity score D_{COM}, and network diversity score D_{DIV} |
| 4. | Compute batch latency time and compute latency score D_{LAT} |
| 5. | Compute DE_{SCORE} = (α₁D_{EXP} + α₂D_{COM} + α₃D_{DIV} ₊ α₄D_{SAL}) · D_{LAT} |
| 6. | Return DE_{SCORE} (F(*)) |

In the example of FIG. 2, at line 1 of Pseudocode 2 the predictor circuitry 206 initializes all neurons of a candidate architecture F (*). In the example of FIG. 2, the normal distribution has a mean of zero and a variance of one. At line 2 of Pseudocode 2 the predictor circuitry 206 samples an input (x) and parameters (δ) of the candidate architecture F(*) with random (e.g., pseudo-random) numbers from the normal distribution. At line 3 of Pseudocode 2, the predictor circuitry 206 computes the expressivity score (D_{EXP}) for the candidate architecture, the complexity score (D_{COM}) for the candidate architecture, the diversity score (D_{DIV}) for the candidate architecture, and the saliency score (D_{SAL}) for the candidate architecture according to Equations 2, 3, 4, 5, 6, and 7 as described above. At line 4 of Pseudocode 2, the predictor circuitry 206 computes an expected duration of an inference of the candidate architecture when executed on target hardware for one batch of input data (e.g., a batch latency time (T_{BATCH})). Additionally, at line 4 of Pseudocode 2, the predictor circuitry 206 computes the latency score for the candidate architecture (D_{LAT}) for the candidate architecture based on the batch latency time (T_{BATCH}).

In the illustrated example of FIG. 2, at line 5 of Pseudocode 2, the predictor circuitry 206 computes a composite score (DE_{SCORE}) for the candidate architecture according to Equation 1 as described above. For example, the predictor circuitry 206 utilizes the latency score as a reciprocal multiplied by the sum of the other scores. As such, when the batch latency time (T_{BATCH}) is smaller (e.g., closer to zero), the entire train-free composite score (DE_{SCORE}) will be larger. In examples disclosed herein, the predictor circuitry 206 computes a composite score (DE_{SCORE}) in only a few forward inferences rather than iteratively training candidate architectures. As such, examples disclosed herein evaluate candidate architectures in an extremely fast (e.g., in a low number of computation cycles compared to other NAS approaches), lightweight (e.g., requiring comparatively less computational resources than other NAS approaches), and data-free (e.g., does not require training data) manner.

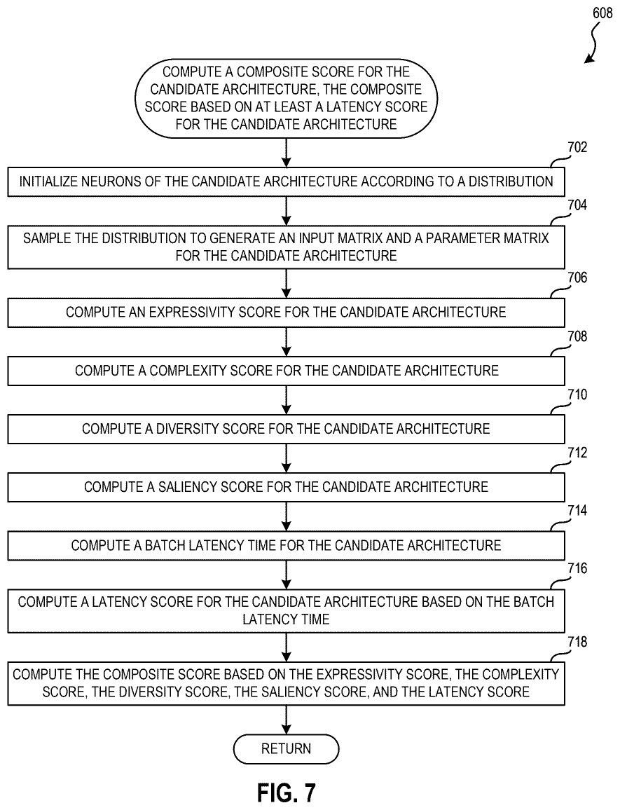

In some examples, the model generation controller 102 includes means for predicting. For example, the means for predicting may be implemented by the predictor circuitry 206. In some examples, the predictor circuitry 206 may be instantiated by processor circuitry such as the example processor circuitry 912 of FIG. 9. For instance, the predictor circuitry 206 may be instantiated by the example microprocessor 1000 of FIG. 10 executing machine executable instructions such as those implemented by at least block 608 of FIG. 6 and/or at least blocks 702, 704, 706, 708, 710, 712, 714, 716, and 718 of FIG. 7. In some examples, the predictor circuitry 206 may be instantiated by hardware logic circuitry, which may be implemented by an ASIC, XPU, or the FPGA circuitry 1100 of FIG. 11 structured to perform operations corresponding to the machine readable instructions. Additionally or alternatively, the predictor circuitry 206 may be instantiated by any other combination of hardware, software, and/or firmware. For example, the predictor circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the search engine circuitry 204 and the predictor circuitry 206 operate to maximize the composite score to determine a desired (e.g., optimal, best, etc.) architecture using a search algorithm (e.g., Pseudocode 1) and the train-free composite score. As described above, the composite score integrates the expected latency of a candidate architecture to evaluate the candidate architecture. In this manner, the search engine circuitry 204 and the predictor circuitry 206 filter out (e.g., focuses the search on) candidate architectures that are suitable for the target hardware (e.g., the target hardware platform 106) in a fine-grained manner. In some examples, the predictor circuitry 206 is instantiated by processor circuitry executing predictor instructions and/or configured to perform operations such as those represented by the flowcharts of FIGS. 6 and/or 7.

In the illustrated example of FIG. 2, the training circuitry 208 implements a training algorithm to train the ML model having the architecture returned by the search algorithm executed by the search engine circuitry 204. In the example of FIG. 2, ML models generated by the search algorithm executed by the search engine circuitry 204 are trained using stochastic gradient descent. However, any other training algorithm may additionally or alternatively be used. In examples disclosed herein, training is performed for a threshold number of epochs to converge on a set of parameters that provide the most accurate inferences for the ML model. In examples disclosed herein, training is performed at a central server of the developer of the model generation controller 102. Training is performed using hyperparameters that control how the learning is performed (e.g., a learning rate, a number of layers to be used in the machine learning model, etc.). In examples disclosed herein, hyperparameters that control the learning rate of the ML model, number of layers of the ML model, the width of the layers, pruning, etc. Such hyperparameters are selected by, for example, a developer of the model generation controller 102. In some examples re-training may be performed. For example, after an end-user downloads a ML model from the model generation controller 102, the end-user may tweak the model for his or her application.

In the illustrated example of FIG. 2, the training circuitry 208 trains the ML model produced by the search algorithm using training data. In examples disclosed herein, the training data originates from publicly available sets such as the CIFAR-10 dataset, the CIFAR-100 dataset, and/or public repositories of text, such as Yelp reviews, IMDB review, and WordNet, among others. Because supervised training is used, the training data is labeled. Labeling is applied to the training data by a human. In some examples, the training data is pre-processed to, for example, identify labels, reformat the training data into a format supported by the ML model, normalize the training data, etc. In some examples, the training data is sub-divided into a training dataset and a validation dataset.

Once training is complete, the ML model is deployed for use as an executable construct that processes an input and provides an output based on the network of nodes and connections defined in the ML model. Examples trained models disclosed herein are high-performance and lightweight models (e.g., provide accurate inferences without consuming excessive computational resources). In some examples, trained ML models are stored at a central server and offered as a service to end-users. In such examples, the trained ML models may then be executed by the central server (e.g., the model generation controller 102) based on inputs received from client devices. In additional or alternative examples, end-users can download trained ML models to client devices. In such examples, the trained ML models may then be executed by the client devices (e.g., the target hardware platform 106). In some examples, the training circuitry 208 is instantiated by processor circuitry executing training instructions and/or configured to perform operations such as those represented by the flowchart of FIG. 6.

In some examples, the model generation controller 102 includes means for training. For example, the means for training may be implemented by the training circuitry 208. In some examples, the training circuitry 208 may be instantiated by processor circuitry such as the example processor circuitry 912 of FIG. 9. For instance, the training circuitry 208 may be instantiated by the example microprocessor 1000 of FIG. 10 executing machine executable instructions such as those implemented by at least blocks 622 and 624 of FIG. 6. In some examples, the training circuitry 208 may be instantiated by hardware logic circuitry, which may be implemented by an ASIC, XPU, or the FPGA circuitry 1100 of FIG. 11 structured to perform operations corresponding to the machine readable instructions. Additionally or alternatively, the training circuitry 208 may be instantiated by any other combination of hardware, software, and/or firmware. For example, the training circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the datastore 210 is configured to store data. For example, the datastore 210 can store one or more files indicative of one or more configuration files, one or more search algorithms, training data, one or more trained models, information related to target hardware, among others. Example configuration files include one or more search spaces and one or more supernets. Example search spaces include optimized ML operations and/or optimized ML components. Such ML operations include convolution operations, operations specific to state-of-the-art (SOTA) models (e.g., ResNet blocks, DLRM blocks, BERT blocks, etc.). Such ML components include kernel size, number of filters, and linear layer dimensions, among others. Example information related to target hardware includes parameter thresholds and latency thresholds. In some examples, the information related to target hardware may be lower-level information such as memory capabilities of target hardware and memory bandwidth of target hardware, among others. In such examples, the model generation controller 102 computes the parameter threshold and the latency threshold based on this lower-level information.

In the illustrated example of FIG. 2, the datastore 210 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example datastore 210 may additionally or alternatively be implemented by one or more double data rate (DDR) memories, such as DDR, DDR2, DDR3, DDR4, mobile DDR (mDDR), etc. The example datastore 210 may additionally or alternatively be implemented by one or more mass storage devices such as hard disk drive(s), compact disk drive(s), digital versatile disk drive(s), solid-state disk drive(s), etc. While in the illustrated example the datastore 210 is illustrated as a single database, the datastore 210 may be implemented by any number and/or type(s) of databases. Furthermore, the data stored in the datastore 210 may be in any data format such as, for example, binary data, comma delimited data, tab delimited data, structured query language (SQL) structures, etc.

FIG. 5 is a visual representation of an example pipeline 500 executed by the model generation controller 102 of FIGS. 1 and/or 2 to generate a desired (e.g., optimal, best, etc.) architecture for a ML model. In the example of FIG. 5, the search engine circuitry 204 accesses an example search space 502 ( [symbol] ) for the ML model. For example, the search engine circuitry 204 accesses the search space 502 from the datastore 210 and/or receives an indication of the search space 502 from a configuration file. In the example of FIG. 5, the search space 502 is unified across in multiple domains, multiple model types, and a single supernet framework. For example, supported domains include the CV domain, the NLP domain, and the RecSys domain. Example supported model types include CNNs, transformer models, and MLP models. Example supernet frameworks include transformer frameworks.

In the illustrated example of FIG. 5, the search space 502 is unified across the CV domain and the NLP domain. Additionally, the search space 502 of FIG. 5 is unified across transformer models and MLP models. In the example of FIG. 5, the search space 502 is unified across a transformer framework. Additionally, in the example of FIG. 5, the search engine circuitry 204 identifies a domain in which the ML model is to operate and target hardware with which to execute the ML model. For example, along with a configuration file, the model generation controller 102 receives one or more indications (e.g., from an end-user) indictive of the domain in which the ML model is to operate and the target hardware with which to execute the ML model.

In the illustrated example of FIG. 5, based on the indicated domain, the search engine circuitry 204 selects a supernet for the ML model from at least two supernets. As described above, the at least two supernets for the ML model correspond to respective domains supported by the search space 502. Additionally, the at least two supernets corresponding to the respective domains share a supernet framework. In the example of FIG. 5, the search engine circuitry 204 execute an example pluggable search algorithm 506 to search the search space 502 for candidate architectures (A). For example, the pluggable search algorithm 506 may be implemented by an example evolution algorithm 506A, an example reinforcement learning algorithm 506B, an example hardware-aware algorithm 506C, and/or an example pruning algorithm 506D.

In the illustrated example of FIG. 5, the search engine circuitry 204 executes an example hardware-aware evolution algorithm as described above in connection with Pseudocode 1. As such, the search engine circuitry 204 generates multiple candidate architectures for the ML model from a supernet, the multiple candidate architectures based on target hardware with which the ML model is to be executed and a search space corresponding to the multiple domains. Additionally, the example predictor circuitry 206 computes multiple composite scores for the multiple candidate architectures, respective composite scores based on at least respective latency scores for the multiple candidate architectures. For example, the composite scores incorporate example expressivity scores 508, example complexity scores 510, example diversity scores 512, example saliency scores 514, and example latency scores 516. In the example of FIG. 5, the search engine circuitry 204 and the predictor circuitry 206 operate to return an architecture for the ML model from the supernet, where the architecture corresponds to a composite score of the multiple composite scores that satisfies a criterion (e.g., a maximum composite score of the multiple composite scores).

In the illustrated example of FIG. 5, the search engine circuitry 204 and the predictor circuitry 206 return an example compact neural architecture 518 that requires comparatively less computational resources than other NAS approaches to generate. Subsequently, the training circuitry 208 trains the compact neural architecture 518 based on training data retrieved from the datastore 210 to generate an example trained compact model 520. Subsequently, the trained compact model 520 can be deployed to a client device (e.g., the target hardware platform 106).

While an example manner of implementing the model generation controller 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example communication circuitry 202, the example search engine circuitry 204, the example predictor circuitry 206, the example training circuitry 208, and/or, more generally, the example model generation controller 102 of FIGS. 1 and/or 2, may be implemented by hardware alone or by hardware in combination with software and/or firmware. Thus, for example, any of the example communication circuitry 202, the example search engine circuitry 204, the example predictor circuitry 206, the example training circuitry 208, and/or, more generally, the example model generation controller 102 of FIGS. 1 and/or 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model generation controller 102 of FIG. 1 may include one or more elements, processes, and/or devices in addition to, or instead of, those illustrated in FIG. 2, and/or may include more than one of any or all of the illustrated elements, processes, and devices.

Flowcharts representative of example machine readable instructions, which may be executed to configure processor circuitry (e.g., the machine readable instructions cause processor circuitry) to implement the model generation controller 102 of FIGS. 1 and/or 2, are shown in FIGS. 6 and 7. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6 and 7, many other methods of implementing the example model generation controller 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and/or 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by example processor circuitry to implement the model generation controller 102 of FIGS. 1 and/or 2 to generate machine learning model architectures. The machine readable instructions and/or the operations 600 of FIG. 6 begin at block 602, at which the communication circuitry 202 receives one or more inputs associated with a query to the model generation controller 102 of FIG. 1. For example, the query may be a request from a client device to generate a trained ML model to operate in a particular domain on particular hardware (e.g., the target hardware platform 106).

In the illustrated example of FIG. 6, the one or more inputs are indicative of the domain in which the ML model is to operate and the target hardware with which the ML model is to be executed. The one or more inputs indicative of the target hardware may identify a model number of the target hardware and/or some other identifying information of the target hardware. As described below, in some examples the search engine circuitry 204 may utilize the identifying information to determine a parameter threshold for the target hardware and/or a latency threshold for the target hardware (e.g., by accessing a lookup table (LUT), accessing the datastore 210, etc.). In some examples, the one or more inputs indicative of the target hardware may include the parameter threshold for the target hardware and the latency threshold for the target hardware.

In the illustrated example of FIG. 6, at block 604, based on the domain, the search engine circuitry 204 selects a supernet for the ML model from at least two supernets. For example, as described above, the communication circuitry 202 may receive a configuration file with the query and/or a configuration file may be stored in the datastore 210. The example configuration file indicates supported domains, a unified search space, and supernets for the supported domains. At block 605, the model generation controller 102 implements an example search algorithm to develop an architecture for the ML model from the supernet. Example search algorithms include evolution algorithms, reinforcement learning algorithms, hardware-aware algorithms, and/or pruning algorithms. In the example of FIG. 6, the model generation controller 102 implements an example hardware-aware evolution algorithm at block 605.

In the illustrated example of FIG. 6, at block 606, the search engine circuitry 204 generates a candidate architecture for the ML model from the supernet based on the target hardware and a search space corresponding to the multiple domains supported by the search engine circuitry 204. For example, the search engine circuitry 204 accesses a unified search space that supports the CV domain and the NLP domain to generate the candidate architecture. At block 608, the predictor circuitry 206 computes a composite score for the candidate architecture based on at least a latency score for the candidate architecture. For example, the predictor circuitry 206 implements Pseudocode 2 as described above to compute the composite score for the candidate architecture. An example implementation of block 608 is discussed in connection with FIG. 7.

In the illustrated example of FIG. 6, at block 610, the search engine circuitry 204 updates a group of composite scores with the composite score corresponding to the candidate architecture. The search engine circuitry 204 also updates the group with the candidate architecture. At block 612, the search engine circuitry 204 generates a mutation of the candidate architecture. For example, the search engine circuitry 204 generates the mutation based on a mutation size parameter, the search space for the ML model, a parameter threshold for the target hardware, a latency threshold for the target hardware, a mutation probability, and the group of composite scores and corresponding candidate architectures. In some examples, the search engine circuitry 204 may access information identifying the target hardware (e.g., a model number, memory and/or computational capacity of the target hardware, etc.) and utilize such information to determine the parameter threshold and/or the latency threshold (e.g., by looking up such thresholds in the datastore 210, accessing a LUT, etc.). In additional or alternative examples, the parameter threshold and/or the latency threshold are included in one or more inputs received by the communication circuitry 202.

In the illustrated example of FIG. 6, at block 614, the search engine circuitry 204 generates a crossover of the candidate architecture. For example, the search engine circuitry 204 generates the crossover based on a crossover size parameter, the search space for the ML model, the parameter threshold for the target hardware, the latency threshold for the target hardware, and the group of composite scores and corresponding candidate architectures. At block 616, the search engine circuitry 204 generates an additional candidate architecture for the ML model as a combination of the mutation and the crossover. For example, the search engine circuitry 204 generates an additional candidate architecture for the ML model as a union of the mutation and the crossover.

In the illustrated example of FIG. 6, at block 618, the search engine circuitry 204 determines whether there is an additional search iteration to perform in the search algorithm. In response to the search engine circuitry 204 determining that there is an additional search iteration to perform (block 618: YES), the machine readable instructions and/or the operations 600 return to block 608. In response to the search engine circuitry 204 determining that there is not an additional search iteration to perform (block 618: NO), the machine readable instructions and/or the operations 600 proceed to block 620.

In the illustrated example of FIG. 6, at block 620, the search engine circuitry 204 returns an architecture for the ML model from the supernet. For example, the architecture corresponds to a composite score of the group of composite scores that satisfies a criterion. In the example of FIG. 6, the criterion is that the composite score is the largest of the group of composite scores. At block 622, using the architecture for the ML model, the training circuitry 208 trains the ML model on a training dataset. At block 624, the training circuitry 208 deploys the trained ML model. For example, the training circuitry 208 instructions the communication circuitry 202 to transmit (e.g., cause transmission) of the trained ML model to a client device such as the target hardware platform 106. In some examples, the training circuitry 208 causes storage of the trained ML model in the datastore 210. After block 624, the machine readable instructions and/or the operations 600 terminate.

FIG. 7 is a flowchart representative of example machine readable instructions and/or example operations 608 that may be executed and/or instantiated by example processor circuitry to implement the model generation controller 102 of FIGS. 1 and/or 2 to compute a composite score a candidate machine learning model architecture. The machine readable instructions and/or the operations 608 of FIG. 7 begin at block 702, at which the predictor circuitry 206 initializes the neurons of the candidate architecture according to a distribution. For example, the predictor circuitry 206 initializes the neurons of the candidate architecture by a normal distribution having a mean of zero and a variance of one.

In the illustrated example of FIG. 7, at block 704, the predictor circuitry 206 samples the distribution to generate an input matrix and a parameter matrix for the candidate architecture. For example, the predictor circuitry 206 samples the input and the parameters with random (e.g., pseudo-random) numbers from the normal distribution. At block 706, the predictor circuitry 206 computes an expressivity score for the candidate architecture. For example, the predictor circuitry 206 implements Equation 2 as described above to compute the expressivity score.

In the illustrated example of FIG. 7, at block 708, the predictor circuitry 206 computes a complexity score for the candidate architecture. For example, the predictor circuitry 206 implements Equations 3 and 4 as described above to compute the complexity score. At block 710, the predictor circuitry 206 computes a diversity score for the candidate architecture. For example, the predictor circuitry 206 implements Equation 5 as described above to compute the diversity score. At block 712, the predictor circuitry 206 computes a saliency score for the candidate architecture. For example, the predictor circuitry 206 implements Equation 6 as described above to compute the saliency score.

In the illustrate example of FIG. 7, at block 714, the predictor circuitry 206 computes a batch latency time for the candidate architecture. For example, the batch latency time corresponds to an expected duration of an inference of the candidate architecture when executed on target hardware for one batch of input data. At block 716, the predictor circuitry 206 computes a latency score for the candidate architecture based on the batch latency time. For example, the predictor circuitry 206 implements Equation 7 as described above to compute the latency score. At block 718, the predictor circuitry 206 computes the composite score for the candidate architecture based on the expressivity score, the complexity score, the diversity score, the saliency score, and the latency score. For example, the predictor circuitry 206 implements Equation 1 as described above to compute the composite score.

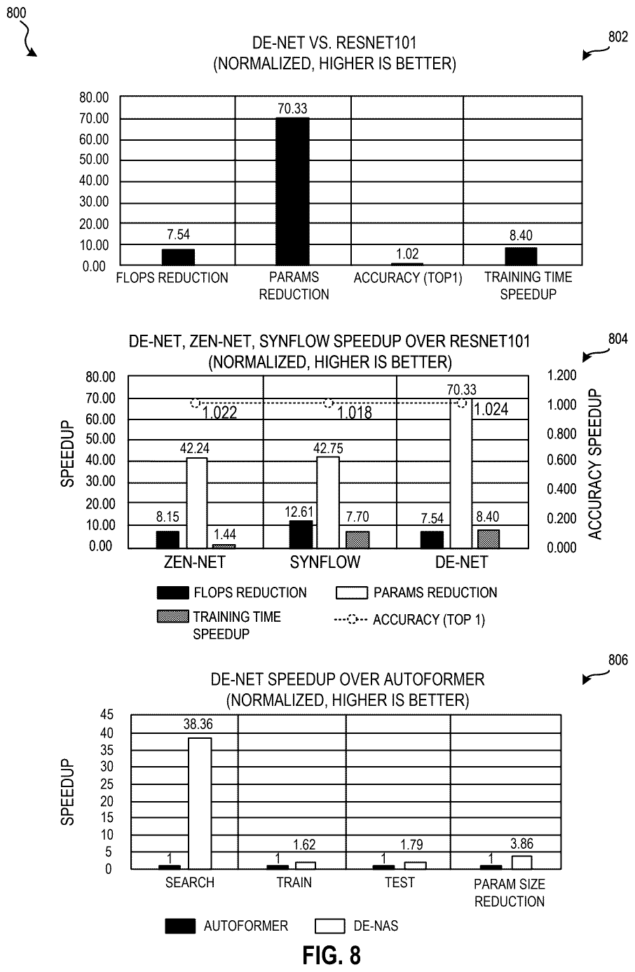

FIG. 8 illustrates graphical illustrations 800 comparing performance of the model generation controller 102 of FIGS. 1 and/or 2 and other neural architecture search approaches. The graphical illustrations 800 include an example first graphical illustration 802, an example second graphical illustration 804, and an example third graphical illustration 806. In the example of FIG. 8, the graphical illustrations 800 illustrate the number of floating point operations per second (FLOPS) of models, the number of parameters of models, and performance metrics (accuracy, training time, inference time, etc.) of models. Disclosed examples have been tested and validated for multiple sample applications including the CV domain and NLP domain.

In the illustrated example of FIG. 8, the first graphical illustration 802 illustrates a comparison between a model (DE-Net) generated by the model generation controller 102 and the generic ResNet101 model. In the example of FIG. 8, the DE-Net model and the generic ResNet101 model were executed on an Intel® Xeon Gold 6252 server. As illustrated in the first graphical illustration 802, the DE-Net model generated by the model generation controller 102 achieves a 70 times reduction in the number of parameters and an 8.4 times reduction in training time with 2% better accuracy as compared to the generic ResNet101 model on the CIFAR-10 dataset.

In the illustrated example of FIG. 8, the second graphical illustration 804 illustrates a comparison of improvements achieved by the DE-Net model generated by the model generation controller 102 and models generated using two SOTA zero-cost NAS approaches: Zen-NAS and Synflow, over the generic ResNet101 model. The second graphical illustration 804 illustrates results for models trained on the CIFAR-10 dataset. As illustrated in the second graphical illustration 804, the DE-Net model generated by the model generation controller 102 achieves a 70 times reduction in the number of parameters and an 8.4 times reduction in training time as compared to the generic ResNet101 model. These reductions in parameter count and training time achieved by the DE-Net model generated by the model generation controller 102 are greater than the reductions in parameter count and training time achieved by either the Zen-NAS or Synflow developed models. Additionally, the improvement in accuracy achieved by the DE-Net model generated by the model generation controller 102 is greater than the improvement in accuracy achieved by either the Zen-NAS or Synflow developed models. The reduction in FLOPS achieved by the DE-Net model generated by the model generation controller 102 is comparable to that achieved by the Zen-NAS and Synflow developed models.

In the illustrated example of FIG. 8, the third graphical illustration 806 illustrates a comparison between (1) the model generation controller 102 and the DE-Net model generated by the model generation controller 102 and (2) a SOTA NAS approach, Autoformer, and an Autoformer developed model. The third graphical illustration 806 illustrates results for a transformer-based DE-Net model trained on the CIFAR-10 dataset. As illustrated in the third graphical illustration 806, the model generation controller 102 achieved a 38.36 times speedup in search time over Autoformer and a 1.62 times speedup in training time over Autoformer. The DE-Net model generated by the model generation controller 102 achieved a 1.79 times speedup in inference over the Autoformer developed model and a 3.86 times reduction in the number of parameters as compared to the Autoformer developed model.

FIG. 9 is a block diagram of an example processor platform 900 structured to execute and/or instantiate the machine readable instructions and/or the operations 600 of FIG. 6 and/or the machine readable instructions and/or the operations 608 of FIG. 7 to implement the model generation controller 102 of FIGS. 1 and/or 2. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example search engine circuitry 204, the example predictor circuitry 206, and the example training circuitry 208.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc. In this example, the interface circuitry 920 implements the communication circuitry 202.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 928 implement the datastore 210.

The machine readable instructions 932, which may be implemented by the machine readable instructions and/or the operations 600 of FIG. 6 and/or the machine readable instructions and/or the operations 608 of FIG. 7 may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 6 and/or 7 to effectively instantiate the circuitry of FIG. 2 as logic circuits to perform the operations corresponding to those machine readable instructions. In some such examples, the circuitry of FIG. 2 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 6 and/or 7.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry 1016 (sometimes referred to as arithmetic and logic circuitry, an ALU, etc.), a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 (e.g., control circuitry) includes semiconductor-based circuits structured to control data movement (e.g., coordinate data movement) within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 6 and/or 7 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 6 and/or 7. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 6 and/or 7. As such, the FPGA circuitry 1100 may be structured to effectively instantiate some or all of the machine readable instructions of the flowcharts of FIGS. 6 and/or 7 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 6 and/or 7 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 6 and/or 7 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 6 and/or 7 may be executed by one or more of the cores 1002 of FIG. 10, a second portion of the machine readable instructions represented by the flowcharts of FIGS. 6 and/or 7 may be executed by the FPGA circuitry 1100 of FIG. 11, and/or a third portion of the machine readable instructions represented by the flowcharts of FIGS. 6 and/or 7 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

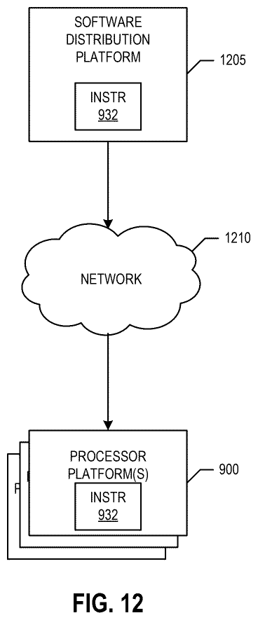

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the machine readable instructions and/or the operations 600 of FIG. 6 and/or the machine readable instructions and/or the operations 608 of FIG. 7, as described above. The one or more servers of the example software distribution platform 1205 are in communication with an example network 1210, which may correspond to any one or more of the Internet and/or any of the example networks 104, 926 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions 932 of FIG. 9, may be downloaded to the example processor platform 900, which is to execute the machine readable instructions 932 to implement the model generation controller 102 of FIGS. 1 and/or 2. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that generate hardware-aware machine learning model architectures for multiple domains without training. Examples disclosed herein greatly simplify and accelerate how ML models are built (e.g., by data scientists), allowing such models to be developed on general purpose processor circuitry such as the Intel® Xeon processors and by end-users having little technical expertise. For example, by generating models from inputs indicative of a domain in which the model is to operate and target hardware with which to execute the model, examples disclosed herein allow end-users that have limited technical expertise to develop models. As described above, examples disclosed herein improve end-to-end AI on general purpose processor circuitry such as the Intel® Xeon processors by providing popular models (e.g., ResNet, DLRM, BERT models, etc.) that are lighter (e.g., requiring comparatively less computational resources than other NAS approaches), have higher inference throughput, and provide the same or close to the same metrics (e.g., accuracy) as SOTA models. Disclosed systems, methods, apparatus, and articles of manufacture improve the efficiency of using a computing device by greatly reducing NAS search time. For example, by utilizing a train-free approach, disclosed examples do not require iterative training and evaluation on candidate architectures. Thus, search time is dramatically reduced compared to generic NAS approaches. As such, accelerator circuitry (e.g., GPUs) need not be utilized to implement examples disclosed herein. Instead, computationally, less expensive general purpose processor circuitry, such as CPUs, can conduct NAS searches disclosed herein. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to generate hardware-aware machine learning model architectures for multiple domains without training are disclosed herein. Further examples and combinations thereof include the following:

Example 1 includes an apparatus to generate hardware-aware machine learning (ML) model architectures for multiple domains without training, the apparatus comprising at least one memory, machine readable instructions, and processor circuitry to at least one of instantiate or execute the machine readable instructions to generate multiple candidate architectures for a ML model based on target hardware with which the ML model is to be executed and a search space applicable to the multiple domains, compute respective composite scores for the multiple candidate architectures, the respective composite scores based on at least respective latency scores for the multiple candidate architectures, and select an architecture for the ML model from the multiple candidate architectures, the selected architecture corresponding to a composite score associated with the selected architecture that satisfies a criterion.

Example 2 includes the apparatus of example 1, wherein the processor circuitry is to select a supernet for the ML model based on a domain in which the ML model is to operate, the supernet including one or more candidate architectures for the ML model, the supernet being selected from at least two supernets, the at least two supernets corresponding to respective domains of the multiple domains.

Example 3 includes the apparatus of example 2, wherein the at least two supernets corresponding to the respective domains share a supernet framework associated with the ML model.

Example 4 includes the apparatus of any of examples 1, 2, or 3, wherein to compute the respective composite scores for the multiple candidate architectures, the processor circuitry is to compute respective products of respective hyperparameters and one or more of an expressivity score, a complexity score, a diversity score, and a saliency score for a first candidate architecture, and compute a first composite score corresponding to the first candidate architecture as a product of (1) a latency score for the first candidate architecture and (2) a sum of the respective products.

Example 5 includes the apparatus of example 4, wherein the respective hyperparameters are binary values, and the processor circuitry is to adjust the respective hyperparameters based on a domain corresponding to a supernet selected for the ML model.

Example 6 includes the apparatus of any of examples 1, 2, 3, 4, or 5 wherein the criterion includes the composite score being a largest one of the respective composite scores for the multiple candidate architectures.

Example 7 includes the apparatus of any of examples 1, 2, 3, 4, 5, or 6, wherein the multiple domains include a computer vision domain, a natural language processing domain, and a recommender system domain.

Example 8 includes a non-transitory machine readable storage medium comprising instructions that, when executed, cause processor circuitry to at least generate multiple candidate architectures for a machine learning (ML) model based on target hardware with which the ML model is to be executed and a search space applicable to multiple domains, compute respective composite scores for the multiple candidate architectures, the respective composite scores based on at least respective latency scores for the multiple candidate architectures, and select an architecture for the ML model from the multiple candidate architectures for the ML model, the selected architecture corresponding to a composite score associated with the selected architecture that satisfies a criterion.

Example 9 includes the non-transitory machine readable storage medium of example 8, wherein the instructions cause the processor circuitry to select a supernet for the ML model based on a domain in which the ML model is to operate, the supernet including one or more candidate architectures for the ML model, the supernet being selected from at least two supernets, the at least two supernets corresponding to respective domains of the multiple domains.

Example 10 includes the non-transitory machine readable storage medium of example 9, wherein the at least two supernets corresponding to the respective domains share a supernet framework associated with the ML model.

Example 11 includes the non-transitory machine readable storage medium of any of examples 8, 9, or 10, wherein to compute the respective composite scores for the multiple candidate architectures, the instructions cause the processor circuitry to compute respective products of respective hyperparameters and one or more of an expressivity score, a complexity score, a diversity score, and a saliency score for a first candidate architecture, and compute a first composite score corresponding to the first candidate architecture as a product of (1) a latency score for the first candidate architecture and (2) a sum of the respective products.

Example 12 includes the non-transitory machine readable storage medium of example 11, wherein the respective hyperparameters are binary values, and the instructions cause the processor circuitry to adjust the respective hyperparameters based on a domain corresponding to a supernet selected for the ML model.

Example 13 includes the non-transitory machine readable storage medium of any of examples 8, 9, 10, 11, or 12, wherein the criterion includes the composite score being a largest one of the respective composite scores for the multiple candidate architectures.

Example 14 includes the non-transitory machine readable storage medium of any of examples 8, 9, 10, 11, 12, or 13, wherein the multiple domains include a computer vision domain, a natural language processing domain, and a recommender system domain.

Example 15 includes a method to generate hardware-aware machine learning (ML) model architectures for multiple domains without training, the method comprising generating, by executing an instruction with processor circuitry, multiple candidate architectures for a ML model based on target hardware with which the ML model is to be executed and a search space applicable to the multiple domains, computing, by executing an instruction with the processor circuitry, respective composite scores for the multiple candidate architectures, the respective composite scores based on at least respective latency scores for the multiple candidate architectures, and selecting an architecture for the ML model from the multiple candidate architectures for the ML model, the selected architecture corresponding to a composite score associated with the selected architecture that satisfies a criterion.

Example 16 includes the method of example 15, further including selecting a supernet for the ML model based on a domain in which the ML model is to operate, the supernet including one or more candidate architectures for the ML model, the supernet being selected from at least two supernets, the at least two supernets corresponding to respective domains of the multiple domains.

Example 17 includes the method of example 16, wherein the at least two supernets corresponding to the respective domains share a supernet framework associated with the ML model.

Example 18 includes the method of any of examples 15, 16, or 17, further including computing the respective composite scores for the multiple candidate architectures by computing respective products of respective hyperparameters and one or more of an expressivity score, a complexity score, a diversity score, and a saliency score for a first candidate architecture, and computing a first composite score corresponding to the first candidate architecture as a product of (1) a latency score for the first candidate architecture and (2) a sum of the respective products.

Example 19 includes the method of example 18, wherein the respective hyperparameters are binary values, and the method further includes adjusting the respective hyperparameters based on a domain corresponding to a supernet selected for the ML model.

Example 20 includes the method of any of examples 15, 16, 17, 18, or 19 wherein the criterion includes the composite score being a largest one of the respective composite scores for the multiple candidate architectures.

Example 21 includes the method of any of examples 15, 16, 17, 18, 19, or 20 wherein the multiple domains include a computer vision domain, a natural language processing domain, and a recommender system domain.

Example 22 includes an apparatus to generate hardware-aware machine learning (ML) model architectures for multiple domains without training, the apparatus comprising interface circuitry to receive an input indicative of target hardware with which to execute a ML model, and processor circuitry including one or more of at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus, a Field Programmable Gate Array (FPGA), the FPGA including first logic gate circuitry, a plurality of configurable interconnections, and storage circuitry, the first logic gate circuitry and the plurality of the configurable interconnections to perform one or more second operations, the storage circuitry to store a second result of the one or more second operations, or Application Specific Integrated Circuitry (ASIC) including second logic gate circuitry to perform one or more third operations, the processor circuitry to perform at least one of the first operations, the second operations, or the third operations to instantiate search engine circuitry to generate multiple candidate architectures for the ML model based on the target hardware and a search space applicable to the multiple domains, and predictor circuitry to compute respective composite scores for the multiple candidate architectures, the respective composite scores based on at least respective latency scores for the multiple candidate architectures, the search engine circuitry to select an architecture for the ML model from the multiple candidate architectures for the ML model, the selected architecture corresponding to a composite score associated with the selected architecture that satisfies a criterion.

Example 23 includes the apparatus of example 22, wherein the input is a first input, the interface circuitry is to receive a second input indicative of a domain in which the ML model is to operate, and the processor circuitry is to perform at least one of the first operations, the second operations, or the third operations to instantiate the search engine circuitry to select a supernet for the ML model based on the domain, the supernet including one or more candidate architectures for the ML model, the supernet being selected from at least two supernets, the at least two supernets corresponding to respective domains of the multiple domains.

Example 24 includes the apparatus of example 23, the at least two supernets corresponding to the respective domains share a supernet framework associated with the ML model.

Example 25 includes the apparatus of any of examples 22, 23, or 24 wherein to compute the respective composite scores for the multiple candidate architectures, the processor circuitry is to perform at least one of the first operations, the second operations, or the third operations to instantiate the predictor circuitry to compute respective products of respective hyperparameters and one or more of an expressivity score, a complexity score, a diversity score, and a saliency score for a first candidate architecture, and compute a first composite score corresponding to the first candidate architecture as a product of (1) a latency score for the first candidate architecture and (2) a sum of the respective products.

Example 26 includes the apparatus of example 25, wherein the respective hyperparameters are binary values, and the processor circuitry is to perform at least one of the first operations, the second operations, or the third operations to instantiate the predictor circuitry to adjust the respective hyperparameters based on a domain corresponding to a supernet selected for the ML model.

Example 27 includes the apparatus of any of examples 22, 23, 24, 25, or 26, wherein the criterion includes the composite score being a largest one of the respective composite scores.

Example 28 includes the apparatus of any of example 22, 23, 24, 25, 26, or 27 wherein the multiple domains include a computer vision domain, a natural language processing domain, and a recommender system domain for the multiple candidate architectures.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
at least one processor circuit to at least one of instantiate or execute the machine readable instructions to:
generate multiple candidate architectures for a machine learning (ML) model based on target hardware with which the ML model is to be executed and a search space applicable to multiple domains;
compute respective composite scores for the multiple candidate architectures, the respective composite scores based on at least respective latency scores for the multiple candidate architectures; and
select an architecture for the ML model from the multiple candidate architectures for the ML model, the selected architecture corresponding to a composite score associated with the selected architecture that satisfies a criterion.

2. The apparatus of claim 1, wherein one or more of the at least one processor circuitry is to select a supernet for the ML model based on a domain in which the ML model is to operate, the supernet including one or more candidate architectures for the ML model, the supernet being selected from at least two supernets, the at least two supernets corresponding to respective domains of the multiple domains.

3. The apparatus of claim 2, wherein the at least two supernets corresponding to the respective domains share a supernet framework associated with the ML model.

4. The apparatus of claim 1, wherein to compute the respective composite scores for the multiple candidate architectures, one or more of the at least one processor circuit is to:
compute respective products of respective hyperparameters and one or more of an expressivity score, a complexity score, a diversity score, and a saliency score for a first candidate architecture; and
compute a first composite score corresponding to the first candidate architecture as a product of (1) a latency score for the first candidate architecture and (2) a sum of the respective products.

5. The apparatus of claim 4, wherein the respective hyperparameters are binary values, and one or more of the at least one processor circuit is to adjust the respective hyperparameters based on a domain corresponding to a supernet selected for the ML model.

6. The apparatus of claim 1, wherein the criterion includes the composite score being a largest one of the respective composite scores for the multiple candidate architectures.

7. The apparatus of claim 1, wherein the multiple domains include a computer vision domain, a natural language processing domain, and a recommender system domain.

8. A non-transitory machine readable storage medium comprising instructions that, when executed, cause at least one processor circuit to at least:
generate multiple candidate architectures for a machine learning (ML) model based on target hardware with which the ML model is to be executed and a search space applicable to multiple domains;
compute respective composite scores for the multiple candidate architectures, the respective composite scores based on at least respective latency scores for the multiple candidate architectures; and
select an architecture for the ML model from the multiple candidate architectures for the ML model, the selected architecture corresponding to a composite score associated with the selected architecture that satisfies a criterion.

9. The non-transitory machine readable storage medium of claim 8, wherein the instructions cause one or more of the at least one processor circuit to select a supernet for the ML model based on a domain in which the ML model is to operate, the supernet including one or more candidate architectures for the ML model, the supernet being selected from at least two supernets, the at least two supernets corresponding to respective domains of the multiple domains.

10. The non-transitory machine readable storage medium of claim 9, wherein the at least two supernets corresponding to the respective domains share a supernet framework associated with the ML model.

11. The non-transitory machine readable storage medium of claim 8, wherein to compute the respective composite scores for the multiple candidate architectures, the instructions cause one or more of the at least one processor circuit to:
compute respective products of respective hyperparameters and one or more of an expressivity score, a complexity score, a diversity score, and a saliency score for a first candidate architecture; and
compute a first composite score corresponding to the first candidate architecture as a product of (1) a latency score for the first candidate architecture and (2) a sum of the respective products.

12. The non-transitory machine readable storage medium of claim 11, wherein the respective hyperparameters are binary values, and the instructions cause one or more of the at least one processor circuit to adjust the respective hyperparameters based on a domain corresponding to a supernet selected for the ML model.

13. The non-transitory machine readable storage medium of claim 8, wherein the criterion includes the composite score being a largest one of the respective composite scores for the multiple candidate architectures.

14. The non-transitory machine readable storage medium of claim 8, wherein the multiple domains include a computer vision domain, a natural language processing domain, and a recommender system domain.

15. A method comprising:
generating, by executing an instruction with at least one processor circuit, multiple candidate architectures for a machine learning (ML) model based on target hardware with which the ML model is to be executed and a search space applicable to multiple domains;
computing, by executing an instruction with one or more of the at least one processor circuit, respective composite scores for the multiple candidate architectures, the respective composite scores based on at least respective latency scores for the multiple candidate architectures; and
selecting an architecture for the ML model from the multiple candidate architectures for the ML model, the selected architecture corresponding to a composite score associated with the selected architecture that satisfies a criterion.

16. The method of claim 15, further including selecting a supernet for the ML model based on a domain in which the ML model is to operate, the supernet including one or more candidate architectures for the ML model, the supernet being selected from at least two supernets, the at least two supernets corresponding to respective domains of the multiple domains.

17. The method of claim 16, wherein the at least two supernets corresponding to the respective domains share a supernet framework associated with the ML model.

18. The method of claim 15, further including computing the respective composite scores for the multiple candidate architectures by:
computing respective products of respective hyperparameters and one or more of an expressivity score, a complexity score, a diversity score, and a saliency score for a first candidate architecture; and
computing a first composite score corresponding to the first candidate architecture as a product of (1) a latency score for the first candidate architecture and (2) a sum of the respective products.

19. The method of claim 18, wherein the respective hyperparameters are binary values, and the method further includes adjusting the respective hyperparameters based on a domain corresponding to a supernet selected for the ML model.

20. The method of claim 15, wherein the criterion includes the composite score being a largest one of the respective composite scores for the multiple candidate architectures.

21.-28. (canceled)
